(19) United States
(12) Patent Application Publication
(10) Pub. No.: US 2004/0166241 A1
(43) Pub. Date: Aug. 26, 2004

(54) Molding compositions containing quaternary organophosphonium salts

(75) Inventors: Anthony A Gallo, Olean, NY (US); Mark T. Dimke, Olean, NY (US)

Correspondence Address: Webb Ziesenheim Lodsdon, Orkin & Hanson, P.C., 700 Koppers Building, 436 Seventh Avenue, Pittsburgh, PA, 15219-1818, US

(73) Assignee: Henkel Loctite Corporation

(21) Appl. No.: 10/369,916

(22) Filed: Feb. 20, 2003

(51) Int. Cl. B05D 3/02

(52) U.S. Cl. 427/372.2

(57) ABSTRACT

Molding compositions particularly useful in coating electronic devices such as integrated circuits are disclosed. The molding compositions include an epoxy resin; a hardener for the epoxy resin, a flame retardant compound such as melamine cyanurate, and a quaternary organophosphonium salt for catalyzing a reaction between the epoxy resin and the hardener, such as ethyl triphenyl phosphonium acid acetate. The molding compositions exhibit improved flame retardancy. Also, when multifunctional epoxy resins and multifunctional phenolic hardeners such as those derived from phenol with a degree of branching of at least three are used, the molding compounds including the quaternary organophosphonium salt as a catalyst exhibit long flow and low shrinkage and warpage.

### TECHNICAL FIELD OF THE INVENTION

The present invention relates to molding compounds for electrical and electronic devices, particularly epoxy-based compounds exhibiting flame resistance, moisture resistance, and low warpage and shrinkage.

### BACKGROUND OF THE INVENTION

Epoxy resins are widely used in molding compounds for coating electrical and electronic devices. Such epoxy molding compounds used for encapsulation are generally prepared from a blend of an epoxy resin and phenol hardener, along with other ingredients including fillers, catalysts, flame retardant materials, processing aids and colorants. Epoxy resins in such molding compounds are traditionally diepoxides which include two epoxy groups per molecule, which are reacted with a co-reactant (cross-linking agent or hardener) consisting of acid dianhydride, diamine or diphenol oligomers. Diphenol oligomers such as those derived from novolac phenols, cresol phenols and bisphenol A are particularly preferred in the art as hardeners due to their high reliability.

Flame retardants in epoxy compositions are typically provided for safety purposes. A common flame retardant system is a combination of bromine-containing flame retardants and antimony oxide flame retardant synergists. However, these compounds are pollutants of the environment. Some bromine-containing flame retardants (especially brominated diphenyl ethers) are toxic and possibly carcinogenic. Antimony trioxide is classified by the International Agency for Research on Cancer as a Class 2B carcinogen (i.e., antimony trioxide is a suspect carcinogen based mainly on animal studies). In addition, this compound is often used at a relatively high level (2-4%) and is also slightly water-soluble, leading to further environmental concerns. This concern is highlighted by the fact that integrated circuit manufacturers currently discard up to one half of the total amount of molding compositions used.

Phosphorus-containing compounds have been proposed as flame retardants. For example, U.S. Pat. No. 5,739,187 to Asano et al. discloses epoxy resin compositions as semiconductor encapsulants which include a phosphorus-containing flame retardant to -eliminate the use of antimony trioxide and brominated compounds. However, molding compositions containing conventional phosphorus compounds generally possess undesirable properties such as high moisture absorption, which can cause stress and cracking of the encapsulant at elevated temperatures.

Melamine cyanurate is commonly sold as a flame retardant compound. Although effective as a flame retardant, high levels of this material severely reduce the flowability of molding compounds. As a result, it has been impractical to incorporate melamine cyanurate into molding compounds at appropriate levels for both adequate flame retardancy and flowability.

Unfortunately, reducing the amount of the flame retardant to address such issues compromises flame retardance, with the molding compounds failing to meet the flame retardance standard, UL-94 V-O rating.

Another challenge to formulators of molding compounds for electrical and electronic devices is to provide flame resistance while maintaining acceptable physical properties such as long flow and low warpage and shrinkage. U.S. Pat. No. 5,434,199 discloses a low stress epoxy molding composition which includes a tris-phenolmethane multifunctional epoxy resin in combination with a tris-phenolmethane multifunctional phenolic hardener, along with silicone rubber powder and an organofunctional silicone fluid. The organofunctional silicone fluid is provided to provide flowability to the molding compound.

It would be desirable to provide new flame retardant molding compositions that overcome the disadvantages of the prior art such as environmental concerns and high moisture absorption, while providing acceptable physical properties. Moreover, it would be desirable to provide molding compositions with excellent stress characteristics such as low warpage and shrinkage with improved flowability upon curing.

### SUMMARY OF THE INVENTION

The present invention provides a composition including an epoxy resin; a curing agent for the epoxy resin; a quaternary organophosphonium salt; and a flame retardant compound. In a particular embodiment, the quaternary organophosphonium salt is present in at least an amount sufficient to catalytically effect crosslinking of the epoxy resin and the curing agent when the composition is heated to a temperature of at least 135° C. The composition is suitable for use as a molding compound, and exhibits improved flame resistance after curing thereof, compared to a similar composition that does not contain the quaternary organophosphonium salt.

The quaternary organophosphonium salt is desirably an organophosphonium functional acetic acid ester compound such as ethyl triphenyl phosphonium acid acetate, and the flame retardant compound desirably includes a melamine cyanurate. It has been discovered that the combination of the quaternary organophosphonium salt with the melamine cyanurate provides a synergistic effect to improve the flame retardancy of the compound, with the quaternary organophosphonium salt also catalyzing the reaction of the epoxy resin and the curing agent (hardener).

For purposes of the present invention, the phrase “degree of branching” is meant to describe the number of aromatic groups that are connected through a central carbon atom or a small cluster of carbons, such as a cluster of 2-5 carbons.

In a further embodiment of the invention, the epoxy resin includes a multifunctional epoxy resin derived from phenol and having a degree of branching of at least three, and the curing agent is derived from phenol and has a degree of branching of at least three. Such a composition exhibits reduced warpage and shrinkage when used as a molding composition. A particular desirable composition includes an epoxy resin derived from trisphenol methane and a hardener derived from trisphenol methane.

Also provided is an encapsulant for an electrical or electronic device, as well as a method for coating an electrical or electronic device. The method includes providing a molding composition as set forth above; contacting a surface of the device with the molding composition; and heating the molding composition to a temperature sufficient to cure the molding composition and form a polymer on the surface of the device.

As used herein, a molding composition is cured when it forms a good cull cure (i.e., strong and not brittle).

Other features and advantages of the invention will be apparent from the description of the preferred embodiments thereof, and from the claims.

### DETAILED DESCRIPTION OF THE INVENTION

The present invention is directed to a composition of matter, and in particular to a molding compound such as for use in encapsulating electronic packages such as semiconductor devices. In general, the molding compound includes an epoxy resin and a curing agent for the epoxy resin, as well as a specific type of catalyst to promote crosslinking between the epoxy resin and the curing agent. As will be discussed in further detail herein, the catalyst is a salt of a quaternary organophosphonium compound, which provides improved properties to the molding composition with respect to flame retardance, flowability, warpage and shrinkage.

A typical molding composition as provided by the present invention comprises an epoxy resin; a curing agent for the epoxy resin; a quaternary organophosphonium salt; and a flame retardant compound. Typically the composition is essentially free of bromine and antimony compounds.

There is no restriction on the type of epoxy resin that can be used in the molding compositions so long as it contains two or more reactive oxirane groups. For example, the epoxy resin may be selected from, but not limited to, bisphenol A type epoxy resins, novolac type epoxy resins such as epoxy cresol novolac resin and phenolic novolac epoxy resin, alicyclic epoxy resins, glycidyl type epoxy resins, biphenyl epoxy resins, naphthalene ring-containing epoxy resins, cyclopentadiene-containing epoxy resins, polyfunctional epoxy resins, hydroquinone epoxy resins, and stilbene epoxy resins. The molding compositions can include more than one epoxy resin, for example, a combination of epoxy cresol novolac resin and biphenyl epoxy resin.

As noted, bisphenol and biphenyl epoxy resins, which are traditionally referenced as di-epoxies, and epoxy cresol novalac resins, which are traditionally referenced as multifunctional epoxies, are useful in the present invention. Such epoxies have a degree of branching of two, in that two phenolic groups having pendant epoxies are linked through the same carbon atom. For example, diglycidyl ether of bisphenol A is difunctional, including two phenolic groups with pendant epoxies extending from a central carbon atom. It therefore has a degree of branching of two. Epoxy cresol novolac resins are oftentimes referenced as “multifunctional”, in that they are polymeric compounds with a plurality of pendant epoxy moieties which may extend from the polymeric chain. For example, epoxy cresol novolac resins include the following structure:

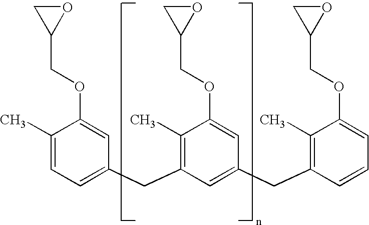

In the instance where n=0, the functionality if this structure would be 2. If n=1, the functionality, is 3, if n=4, the functionality is 4, etc. As such, this compound is traditionally referred to as a multifunctional epoxy resin. However, since only two phenolic groups extend from the same carbon or small cluster of carbons, the degree of branching of this type of resin would be equal to two.

In a particularly desirable embodiment, the epoxy resin is a multifunctional epoxy resin having a degree of branching within the resin backbone of at least three. Thus, particularly desirable multifunctional epoxy resins are those derived from phenol and which include at least three phenolic groups branching directly from the same central carbon atom or central cluster of carbons, with a pendant oxirane group linked to each of the at least three phenolic groups.

Non-limiting examples of useful multifunctional epoxy resins having a degree of branching of at least three include:

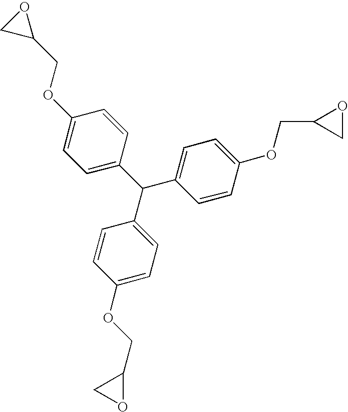

triphenylol methane triglycidyl ether (having a degree of branching of three, represented by three terminal glycidyl ether moieties branching from a central carbon atom); and

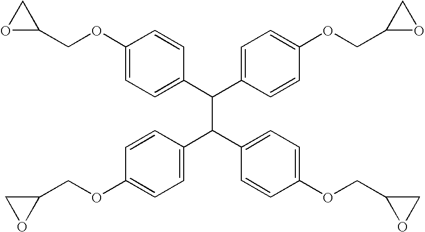

tetra glycidyl ether of tetra phenol ethane (having a degree of branching of four, represented by four terminal glycidyl ether moieties branching from a central two carbon cluster ethyl moiety).

Particularly desirable are epoxy resins derived from tris-phenolmethane, such as triphenylol methane triglycidyl ether.

The multifunctional resin having a degree of branching of at least three may be used alone, or in combination with conventional resins such as those described above.

The epoxy resin typically has a theoretical epoxy equivalent weight of about 150 to 250. The epoxy resin is typically present in the composition of the present invention in an amount of about 1 to 25 percent by weight, often 4 to about 12 percent by weight, and more often, from about 5.5 to about 8.5 percent by weight, based on the total weight of the composition.

The curing agent (hardener) promotes crosslinking of the molding composition to form a polymer composition upon heating of the composition to a temperature of at least 135° C. Some suitable curing agents that can be included in the molding compositions of the present invention are phenol novolac type hardener, cresol novolac type hardener, dicyclopentadiene phenol type hardener, limonene type hardener, and anhydrides. Flexible hardeners having a hydroxyl equivalent weight greater than about 150 are often desirable, such as xylock novalac type hardener. Non-limiting examples of flexible hardeners include bisphenol M commercially available from Borden Chemical, and DEH 85, commercially available from Dow Chemical. Similar to the epoxy resin component, more than one type of curing agent can be included in the molding compositions.

As with the epoxy resin component, multifunctional hardeners having a degree of branching of at least three are particularly desirable in one embodiment of the present invention. Particularly desirable are those derived from tris-phenol and which contain at least three functional groups that are reactive with epoxide groups.

The curing agent is typically present in the composition of the present invention in an amount of about 1 percent by weight to about 10 percent by weight, often from about 1.5 percent by weight to about 6 percent by weight, based on the total weight of the composition.

The composition further includes a catalyst for promoting reaction of the epoxy resin and the hardener. Traditionally, such epoxy compositions incorporate catalysts such as tertiary amines, substituted phosphines, imidazoles, and the like, with compounds such as 1,8-diazabicyclo[5.4.0]undec-7-ene (“DBU”), dicyandiamide (“DICY”) and triphenylphosphine (“TPP”) being particularly well known for use as catalysts.

It has been discovered through the present invention that salts of quaternary organophosphonium compounds are particularly useful as catalysts for epoxy compositions for use in molding compounds. Such compounds are represented by the formula:

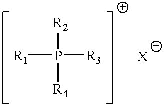

where R₁, R₂, R₃ and R₄ are C₁₋₈ akyl or aryl groups and X is halogen, acetate or phosphate anion. Desirably, the anion is acetate, and at least one of R₁, R₂, R₃ and R₄ is a phenyl group and at least one of R₁, R₂, R₃ and R₄ is methyl, ethyl, propyl or butyl. Organophosphonium functional acetic acid ester compounds are particularly desirable, such as ethyltriphenylphosphonium acid acetate complex (“EtTPPOAc”), commercially available from Rohm and Haas.

It has further been discovered through the present invention that molding compounds including such a quaternary organophosphonium salt provide improved flame resistance when compared to similar compositions that do not contain a quaternary organophosphonium salt. For example, in traditional epoxy compositions incorporating traditional catalysts such as DBU or TPP, a significant amount of a flame retardant component must be included within the composition to impart flame resistance to the composition. Such flame retardants, however, can deleteriously affect the molding compound, such as by reducing the flowability. It has been unexpectedly discovered through the present invention that epoxy compositions including a quaternary organophosphonium salt, such as a phosphonium functional acetic acid ester compound, exhibit improved flame resistance as compared with similar compositions which do not include a quaternary organophosphonium salt. As such, flame retardant epoxy compositions, and in particular, flame retardant epoxy molding compositions, can be prepared with reduced levels of traditional catalysts and with reduced levels of conventional flame retardant compounds, thereby reducing or eliminating any deleterious effect from the additional flame retardant compounds.

The quaternary organophosphonium salt is typically present in the composition of the present invention at least in an amount sufficient to catalytically effect crosslinking of the epoxy resin and curing agent when the composition is heated to a temperature of at least 135° C. Desirably, the quaternary organophosphonium salt is present in the composition at least in an amount sufficient to provide improved flame resistance to the composition after curing thereof, compared to a similar composition that does not contain a quaternary organophosphonium salt. Flame resistance may be measured using any acceptable testing method known to those skilled in the art. A suitable test method is UL 94, with an acceptable rating of V-1 or V-O.

In addition, the composition of the present invention may further include a component specifically designated for imparting flame retardancy to the composition. Non-limiting examples of suitable flame retardants include, but are not limited to, cyanurate functional compounds such as melamine cyanurate, transition metal oxides such as tungsten trioxide, molybdenum trioxide, zinc molybdate, calcium molybdate, and mixtures thereof. Melamine cyanurate is particularly desirable. The flame retardant is present in the composition of the present invention in an amount of up to about 3 percent by weight based on the total weight of the composition, desirably from about 0.4 percent by weight to about 2.8 percent by weight.

A particularly desirable composition of the present invention includes melamine cyanurate in combination with a quaternary organophosphonium salt, an epoxy resin and a hardener for the epoxy resin. It has been discovered that the use of the quaternary organophosphonium salt, and in particular a phosphonium functional acetic acid ester compound, as a catalyst in such a composition improves the flame retardance of the composition, particularly in combination with a melamine cyanurate flame retardant. Therefore, the amount of melamine cyanurate can be decreased below the level typically required to impart flame retardance to a molding composition, which may also serve to limit any deleterious effect in other properties which may be caused by increased levels of melamine cyanurate, such as flowability, as well as environmental concerns.

The compositions of the present invention can include other optional additives well known to those of skill on the art. For example, fillers such as silica, alumina, aluminosilicate, aluminum trihydrate, silicon nitride, clay, talc, mica, kaolin, calcium carbonate, wollastonite, montmorillonite, smectite, and combinations thereof are commonly present in the composition, in amounts of about 20 to 90 percent by weight, often desirably from about 50 to 90 percent by weight, and more desirably from about 60 to 90 percent by weight, based on the total weight of the composition.

A colorant such as carbon black colorant may be included in the composition of the present invention in amounts of about 0 to about 2 percent by weight, more often, from about 0.1 to about 1 percent by weight, when present.

A mold release agent such as carnauba wax, paraffin wax, polyethylene wax, ester waxes (such as EWAX commercially available from Hoechst Chemical), acid waxes (such as SWAX commercially available from Hoechst Chemical), glycerol monostearate, and metallic stearates may be included in the composition of the present invention in amounts of from about 0 to about 2 percent by weight, more often, from about 0.2 to about 1 percent by weight, when present.

A coupling agent such as the silane type coupling agent may be included in the composition of the present invention in amounts of from about 0 to about 2 percent by weight, more often from about 0.3 to about 1 percent by weight, when present.

Ion scavengers such as magnesium aluminum carbonate hydrate, which can be obtained commercially from Kyowa Chemical Industry Co. under the trade name “DHT-4A” are suitable for use in the composition of the present invention and may be present in amounts of from about 0 to about 2 percent by weight, more often from about 0.5 to about 2 percent by weight, when present.

Examples of other additives may include stress relievers such as polyphenyleneoxide, elastomers such as powdered silicone, and adhesion promoters such as azine adhesion promoters, which may be present in amounts of from about 0 to about 3 percent by weight, when present.

Auxiliary catalysts such as DBU, TPP, DICY and 2-methylmidazole are suitable for use in the composition of the present invention and may be present in amounts of from about 0 to about 10 percent by weight, more often from about 0.5 to about 2 percent by weight, when present.

The molding compositions can be prepared by any conventional method. For example, as is known in the art, all of the compounds may be combined and finely ground and dry blended, or the components can be mixed in a step-wise fashion to enhance homogeneous mixing. The mixture can then be treated on a hot differential roll mill such as with a large two-roll mill (one roll heated to about 90° C., and the other cooled with tap water) to produce uniform sheets, which are then ground to a powder after cooling. Alternatively, the mixture can be extruded through a twin screw extruder, as known in the art.

The molding compositions can be molded into various articles by any conventional method, e.g., by using molding apparatus such as a transfer press equipped with a multi-cavity mold for coating electronic devices. Suitable molding conditions include a temperature of about 150° C. to about 200° C. (preferably about 175° C. to about 195° C.) and a pressure of about 400 psi to about 1,500 psi.

The preferred molding compositions cure in about 0.5 minute to about 3 minutes, more preferably, about 1 minute to about 2 minutes. To determine the time for curing (i.e., minimum time needed for forming a good cull cure), the molding composition is placed in the mold press at 190° C. and is inspected after a pre-set period of time (e.g., 3 minutes). If a good cure (i.e., strong and not brittle) is formed, the experiment is repeated with a shorter period of press time until the minimum time period is determined.

The molding compositions of the present invention typically demonstrate a flammability rating of UL 94V-1, more preferably, a flammability rating of UL 94V-0. The ratings are determined by measuring the total burn time of a ⅛″ bar according to the UL 94 flammability test. A 94V-0 and a 94V-1 rating require the total burn time for a single bar to be less than or equal to 10 seconds and 30 seconds, respectively.

As noted above, in a particular embodiment of the invention, the epoxy resin is a multifunctional epoxy resin having a degree of branching within the resin backbone of at least three, and the crosslinking agent is a multifunctional hardener derived from phenol and having a degree of branching of at least three. Particularly desirable epoxy resins are tris-phenolmethane derived resins, such as triphenolyl methane triglycidyl ether, and particularly desirable hardeners are tris-phenolmethane derivatives. Examples of useful resins include 1-trishydroxyphenylmethane glycidyl ether, such as SUMIEPOXY TMH574 commercially available from Sumitomo Corp., and EPPN 501H commercially available from Nippon Kayaku. An example of a useful hardener is MEH 7500 commercially available from Meiwa Kasei K.K.

Epoxy molding compounds including such multifunctional resins and hardeners having a degree of branching of at least three exhibit improved flowability, warpage and shrinkage when compared to molding compounds having multifunctional epoxy resins with traditional catalysts. Epoxy molding compounds which are based on such multifunctional epoxy resins and hardeners and which include conventional catalysts, such as triphenylphosphine or dicyandiamide, normally result in epoxy molding compounds having either low warpage or long flowability, but not both, depending on the specific catalyst involved in the reaction. Accordingly, some sacrifice in either warpage or flowability is apparent depending on the selection of the specific catalyst. It has been unexpectedly discovered through the present invention, however, that incorporating a quaternary organophosphonium salt as the catalyst for such epoxy molding compounds based on multifunctional epoxy resins and hardeners having a degree of branching of at least three provides a molding compound with a combination of long flowability and low warpage. As such, the present invention provides for a molding compound which is improved in that the combination of properties such as long flowability and low warpage are improved over the conventional catalysts, which typically lose flowability properties with improved warpage characteristics.

As noted above, the compositions of the present invention are particularly useful as molding compounds for electrical or electronic devices. In a further embodiment, the present invention provides a method for coating an electrical or electronic device. The method involves providing a molding composition as discussed above, and contacting a surface of an electronic device with the molding composition, such as by coating the composition thereon. The device including the molding composition thereon is then heated to a temperature sufficient to cure the molding composition and form a polymer on the surface of the device. Desirably, the temperature to which the molding composition is heated is typically at least 135° C., often about 165 to 195° C.

The invention will now be described by the following examples. The examples are intended to be illustrative only and are not intended to limit the scope of the invention.

The following examples of molding compositions were prepared by dry blending all of the components simultaneously and testing the compositions.

### EXAMPLES

### Example 1

Five molding compositions represented as Samples 1-5 were prepared according to the formulations as indicated in Table 1 below. Each molding composition contained an epoxy cresol novolac resin with a standard phenol novolac hardener. With the exception of Comparative Sample 1, each composition contained a phosphonium functional acetic acid ester compound as a catalyst. The weight % (wt %) indicated below were calculated based on the total weight of the compositions.

TABLE 1

| | SAMPLE NO. | | | | |
|---|---|---|---|---|---|
| | 1 (comparative) | 2 | 3 | 4 | 5 |
| Silica Filler (wt %) | 82.45 | 82.23 | 82.33 | 82.43 | 82.53 |
| Epoxy Cresol Novolac Resin (wt %) | 5.68 | 5.68 | 5.68 | 5.68 | 5.68 |
| Phenol Novolac Hardener (wt %) | 0.36 | 0.18 | 0.18 | 0.18 | 0.18 |
| Flexible Type Hardener | 3.25 | 3.25 | 3.25 | 3.25 | 3.25 |
| (Bisphenol-M) (wt %) | | | | | |
| Flexible Type Hardener | 1.48 | 1.78 | 1.78 | 1.78 | 1.78 |
| (xylock novolac type) (wt %) | | | | | |
| TPP Catalyst (wt %) | 0.02 | — | — | — | — |
| DBU Catalyst (wt %) | 0.13 | — | — | — | — |
| EtTPPOAc Catalyst (wt %) | — | 0.25 | 0.25 | 0.25 | 0.25 |
| Melamine Cyanurate Flame Retardant | 1.70 | 1.70 | 1.60 | 1.50 | 1.40 |
| (Melapur MC-25 from DSM Corp.) | | | | | |
| (wt %) | | | | | |
| Polyphenyleneoxide Stress Reliever | 1.00 | 1.00 | 1.00 | 1.00 | 1.00 |
| (wt %) | | | | | |
| Carbon Black Colorant (wt %) | 0.30 | 0.30 | 0.30 | 0.30 | 0.30 |
| Azine Adhesion Promoter (curezol 2MZ- | 0.02 | 0.02 | 0.02 | 0.02 | 0.02 |
| Azine from Shikoku Fine Chemical | | | | | |
| Corp.) (wt %) | | | | | |
| Ion Scavenger (wt %) | 1.58 | 1.58 | 1.58 | 1.58 | 1.58 |
| Waxes (wt %) | 0.98 | 0.98 | 0.98 | 0.98 | 0.98 |
| Silane Couple agents (wt %) | 1.05 | 1.05 | 1.05 | 1.05 | 1.05 |

Each of the molding compositions of Samples 1-5 were cured and tested for flammability, gel time, and shelf life stability, with the results shown in Table 2. The flammability properties of the cured compositions were determined by the total burn time of a ⅛″ molded bar according to the UL 94 test. Gel time was determined through a standard testing procedure in which the compound is placed on a thermostatically-controlled hot plate which is controlled at a specified temperature. The compound is stroked with a spatula in a back-and-forth motion until it becomes stiff, with the time to stiffness representing the gel time. Shelf life stability was determined by testing the spiral flow at intervals according to a standard testing practice involving the use of a standard spiral flow mold in a transfer molding press. In the process, a sample of the composition is added to a transfer mold in a standard spiral flow mold, and the mold cycle is activated. When the mold cycle is complete, the mold is opened and the point of farthest continuous flow is recorded.

TABLE 2

| | SAMPLE NO. | | | | |
|---|---|---|---|---|---|
| TEST | 1 | | | | |
| PROCEDURE | (comparative) | 2 | 3 | 4 | 5 |
| Flammability | | | | | |
| Test (UL 94) | | | | | |
| Total Burn Time (sec) | 47 | 15 | 20 | 8 | 29 |
| UL94 V-O Status | Fail | Pass | Pass | Pass | Fail |
| Gel Time (sec) | 26 | 24 | 24 | 24 | 25 |
| Shelf Life Stability | | | | | |
| Spiral Flow at | | | | | |
| Room Temp | | | | | |
| (inches) | | | | | |
| Initial | 34 | 40 | 41 | 41 | 40 |
| 1 day | 28 | 37 | NM* | NM* | NM* |
| 2 days | 23 (68%) | 30 (75%) | NM* | NM* | NM* |
| Spiral Flow at | | | | | |
| 5° C. (inches) | | | | | |
| Initial | 36 | 40 | NM* | NM* | NM* |
| 1 week | 33 | 39 | NM* | NM* | NM* |
| 2 weeks | 31 (86%) | 37 (93%) | NM* | NM* | NM* |

*NM represents not measured

The results of Table 2 demonstrate that molding compositions prepared with a phosphonium functional acetic acid ester compound as a catalyst exhibit improved flame retardancy and flowability. In particular, a comparison of Sample 1 (which represents a comparative composition prepared with TPP and DBU as a catalyst) with Samples 2-4 (which represent inventive compositions prepared with EtTPPOAC as a catalyst) shows that Samples 2-4 have improved flammability ratings compared with Sample 1, which failed to achieve a UL94 V-O rating. Further, Sample 2 clearly exhibits improved shelf life stability as demonstrated through the increased flowability over time as compared with the comparative Sample 1.

### Example 2

Six molding compositions represented as Samples 6-11 were prepared according to the formulations as indicated in Table 3 below. Each molding composition contained a standard epoxy cresol novolac resin and a flexible novolac hardener, along with two known flame retardants at varying amounts. Comparative Samples 6-8 included conventional catalysts, while Samples 9-11 contained a phosphonium functional acetic acid ester compound as a catalyst. The weight % (wt %) indicated below were calculated based on the total weight of the compositions.

TABLE 3

| | SAMPLE NO. | | | | | |
|---|---|---|---|---|---|---|
| | 6 | 7 | 8 | | | |
| | (comparative) | (comparative) | (comparative) | 9 | 10 | 11 |
| Silica Filler (wt %) | 80.98 | 80.98 | 80.98 | 80.86 | 80.86 | 80.86 |
| Epoxy Cresol Novolac Resin | 6.16 | 6.27 | 6.49 | 6.16 | 6.27 | 6.49 |
| (wt %) | | | | | | |
| Phenol Novolac Hardener (wt %) | 0.18 | 0.18 | 0.18 | 0.18 | 0.18 | 0.18 |
| Flexible Type Hardener | 5.47 | 5.56 | 5.74 | 5.47 | 5.56 | 5.74 |
| (xylock novolac type) (wt %) | | | | | | |
| TPP Catalyst (wt %) | 0.02 | 0.02 | 0.02 | — | — | — |
| DBU Catalyst (wt %) | 0.11 | 0.11 | 0.11 | — | — | — |
| EtTPPOAc Catalyst (wt %) | — | — | — | 0.25 | 0.25 | 0.25 |
| Melamine Cyanurate Flame | 1.00 | 0.80 | 0.40 | 1.00 | 0.80 | 0.40 |
| Retardant (wt %) | | | | | | |
| WO₃ Flame Retardant (wt %) | 0.75 | 0.75 | 0.75 | 0.75 | 0.75 | 0.75 |
| Polyphenyleneoxide Stress | 1.50 | 1.50 | 1.50 | 1.50 | 1.50 | 1.50 |
| Reliever (wt %) | | | | | | |
| Carbon Black Colorant (wt %) | 0.30 | 0.30 | 0.30 | 0.30 | 0.30 | 0.30 |
| Azine Adhesion Promoter (wt %) | 0.02 | 0.02 | 0.02 | 0.02 | 0.02 | 0.02 |
| Ion Scavenger (wt %) | 1.58 | 1.58 | 1.58 | 1.58 | 1.58 | 1.58 |
| Waxes (wt %) | 0.88 | 0.88 | 0.88 | 0.88 | 0.88 | 0.88 |
| Silane Couple agents (wt %) | 1.05 | 1.05 | 1.05 | 1.05 | 1.05 | 1.05 |

Each of the molding compositions of Samples 6-11 were cured and tested for flammability, gel time, and shelf life stability in a similar manner as in Example 1, with the results shown in Table 4.

TABLE 4

| | SAMPLE NO. | | | | | |
|---|---|---|---|---|---|---|
| | 6 | 7 | 8 | | | |
| TEST PROCEDURE | (comparative) | (comparative) | (comparative) | 9 | 10 | 11 |
| Flammability Test (UL 94) | | | | | | |
| Total Burn Time (sec) | 44 | 21 | 16 | 1 | 3 | 13 |
| UL94 V-O Status | Fail | Fail | Pass | Pass | Pass | Pass |
| Gel Time (sec) | 24 | 23 | 24 | 21 | 21 | 22 |
| Flowability | | | | | | |
| Spiral Flow at Room | 35 | 36 | 41 | 37 | 37 | 41 |
| Temp (inches) | | | | | | |

The results of Table 4 demonstrate that molding compositions prepared with a phosphonium functional acetic acid ester compound as a catalyst exhibit improved flame retardancy and flowability. In particular, a comparison of Samples 6-8 (which represent comparative compositions prepared with TPP and DBU as a catalyst) with Samples 9-11 (which represent inventive compositions prepared with EtTPPOAC as a catalyst) shows a decrease in total burn time for the samples including EtTPPOAC, a decrease in gel time, and at least the same or improved flowability.

### Example 3

Six molding compositions represented as Samples 12-17 were prepared according to the formulations as indicated in Table 5 below. Each molding composition contained a standard epoxy cresol novolac resin and a flexible novolac hardener, along with melamine cyanurate as a flame retardant at varying amounts. Comparative Samples 12-14 included conventional catalysts, while Samples 15-17 contained a phosphonium functional acetic acid ester compound as a catalyst. The weight % (wt %) indicated below were calculated based on the total weight of the compositions.

TABLE 5

| | SAMPLE NO. | | | | | |
|---|---|---|---|---|---|---|
| | 12 | 13 | 14 | | | |
| | comparative | comparative | comparative | 15 | 16 | 17 |
| Silica Filler (wt %) | 83.68 | 83.68 | 83.68 | 83.57 | 83.57 | 83.57 |
| Epoxy Cresol Novolac Resin | 5.53 | 5.64 | 5.75 | 5.53 | 5.64 | 5.75 |
| (wt %) | | | | | | |
| Phenol Novolac Hardener (wt %) | 0.18 | 0.18 | 0.18 | 0.18 | 0.18 | 0.18 |
| Flexible Type Hardener | 4.84 | 4.93 | 5.02 | 4.84 | 4.93 | 5.02 |
| (xylock novolac type) (wt %) | | | | | | |
| TPP Catalyst (wt %) | 0.02 | 0.02 | 0.02 | — | — | — |
| DBU Catalyst (wt %) | 0.12 | 0.12 | 0.12 | — | — | — |
| EtTPPOAc Catalyst (wt %) | — | — | — | 0.25 | 0.25 | 0.25 |
| Melamine Cyanurate Flame | 0.80 | 0.60 | 0.40 | 0.80 | 0.60 | 0.40 |
| Retardant (wt %) | | | | | | |
| Polyphenyleneoxide Stress | 1.00 | 1.00 | 1.00 | 1.00 | 1.00 | 1.00 |
| Reliever (wt %) | | | | | | |
| Carbon Black Colorant (wt %) | 0.30 | 0.30 | 0.30 | 0.30 | 0.30 | 0.30 |
| Azine Adhesion Promoter (wt %) | 0.02 | 0.02 | 0.02 | 0.02 | 0.02 | 0.02 |
| Ion Scavenger (wt %) | 1.58 | 1.58 | 1.58 | 1.58 | 1.58 | 1.58 |
| Waxes (wt %) | 0.88 | 0.88 | 0.88 | 0.88 | 0.88 | 0.88 |
| Silane Couple agents (wt %) | 1.05 | 1.05 | 1.05 | 1.05 | 1.05 | 1.05 |

Each of the molding compositions of Samples 12-17 were cured and tested for flammability, gel time, and shelf life stability in a similar manner as in Example 1, with the results shown in Table 6.

TABLE 6

| | SAMPLE NO. | | | | | |
|---|---|---|---|---|---|---|
| TEST | 12 | 13 | 14 | | | |
| PROCEDURE | comparative | comparative | comparative | 15 | 16 | 17 |
| Flammability Test (UL 94) | | | | | | |
| Total Burn Time (sec) | 6 | 5 | 23 | 2 | 1 | 15 |
| UL94 V-O Status | Pass | Pass | Pass | Pass | Pass | Pass |
| Gel Time (sec) | 21 | 22 | 22 | 20 | 21 | 20 |
| Flowability | | | | | | |
| Spiral Flow at Room | 33 | 33 | 34 | 33 | 32 | 33 |
| Temp (inches) | | | | | | |

The results of Table 6 demonstrate that molding compositions prepared with a phosphonium functional acetic acid ester compound as a catalyst exhibit flame retardancy with a low level of additional flame retardant, without sacrifice in the flowability of the composition. In particular, a comparison of Samples 12-14 (which represent comparative compositions prepared with TPP and DBU as a catalyst) with Samples 15-17 (which represent inventive compositions prepared with EtTPPOAC as a catalyst) shows a decrease in total burn time for the samples including EtTPPOAC, and a slight decrease in gel time, without any significant change in flowability.

### Example 4

A molding composition according to the present invention was prepared according to the following formulation:

TABLE 7

| | SAMPLE 18 | SAMPLE 19 |
|---|---|---|
| Silica Filler (wt %) | 80.59 | 80.05 |
| Epoxy Cresol Novolac Resin (wt %) | 6.09 | 7.89 |
| Phenol Novolac Hardener (wt %) | 0.18 | 3.73 |
| Flexible Type Hardener | 5.26 | — |
| (xylock novolac type, p-bis(metboxy- | | |
| methyl)benzene-phenol copolymer) (wt %) | | |
| Flexible Type Hardener | — | 1.56 |
| (DEH-85 from Dow Chemical) (wt %) | | |
| EtTPPOAc Catalyst (wt %) | 0.23 | 0.24 |
| Melamine Cyanurate | 2.80 | 2.80 |
| Flame Retardant (wt %) | | |
| Polyphenyleneoxide Stress Reliever (wt %) | 1.02 | 1.10 |
| Carbon Black Colorant (wt %) | 0.30 | 0.35 |
| Azine Adhesion Promoter (wt %) | 0.02 | 0.03 |
| Ion Scavenger (wt %) | 1.58 | 0.80 |
| Waxes (wt %) | 0.88 | 0.75 |
| Silane Couple agents (wt %) | 1.05 | 0.70 |
| TOTAL | 100.0 | 100.0 |

The molding compositions of Samples 18 and 19 were cured and tested for flammability, gel time, and shelf life stability as in Example 1 above. The molding composition of Samples 18 and 19 passed flammability testing with a UL94 V-O rating, and exhibited excellent gel time and flowability properties for shelf life stability.

### Example 5

Three molding compositions represented as Samples 20-22 were prepared according to the formulations as indicated in Table 8 below. Each molding composition contained a tris-phenolmethane derived multifunctional epoxy resin and a tris-phenolmethane derived multifunctional hardener. Comparative Samples 20-21 included conventional catalysts, while Sample 22 contained a phosphonium functional acetic acid ester compound as a catalyst. The weight % (wt %) indicated below were calculated based on the total weight of the compositions.

TABLE 8

| | SAMPLE NO. | | |
|---|---|---|---|
| | 20 | 21 | 22 |
| Silica Filler (wt %) | 88.70 | 88.35 | 88.67 |
| Biphenyl Epoxy Resin (wt %) | 2.70 | 2.69 | 2.70 |
| (Yuka Shell Epoxy K.K. RSF 1407) | | | |
| Multifunctional Epoxy Resin (wt %) | 2.59 | 2.58 | 2.59 |
| (Nippon Kayaku EPPN 501H) | | | |
| Multifunctional Hardener (wt %) | 2.76 | 2.75 | 2.76 |
| (Meiwa Kasei K.K. MEH 7500) | | | |
| TPP Catalyst (wt %) | 0.10 | — | — |
| Dicyandiamide Catalyst (wt %) | — | 0.36 | — |
| Amine Hardener (wt %) | — | 0.13 | — |
| (Resolution Performance Products | | | |
| EPICURE P-101) | | | |
| EtTPPOAc Catalyst (wt %) | — | — | 0.13 |
| Melamine Cyanurate Flame Retardant (wt %) | 0.37 | 0.37 | 0.37 |
| Elastomer (wt %) | 0.72 | 0.71 | 0.72 |
| (powdered silicone) | | | |
| Carbon Black Colorant (wt %) | 0.24 | 0.24 | 0.24 |
| Ion Scavenger (wt %) | 0.42 | 0.42 | 0.42 |
| Waxes (wt %) | 0.58 | 0.58 | 0.57 |
| Silane Couple agents (wt %) | 0.83 | 0.82 | 0.83 |

Each of the molding compositions of Samples 20-22 were cured and tested for gel time and flowability as in Example 1 above, as well as shrinkage and warpage. Shrinkage was determined based on ASTM-D955-89. Warpage was determined using a standard test involving molding the material through transfer molding a 29 mm²×1.25 mm mold cap onto a bare substrate having the following description: Unimicron VT52 board, 35 mm² part, 5 parts per board, 4 layer, BT laminate, T_{g} 190° C., 0.56 mm thick, Solder Mask Taiyo PSR-4000 AUS303. The warpage is measured by taking to co-planarity value obtained on an AkroMetrics TherMoire PS88 with a 100 line per inch grating Shadow Moire interferometer at room temperature. The results are shown in Table 9.

TABLE 9

| | SAMPLE NO. | | |
|---|---|---|---|
| TEST PROCEDURE | 20 | 21 | 22 |
| Gel Time at 175° C. (sec) | 20 | 15 | 22 |
| Flow at 175° C. (inches) | 31 | 24 | 42 |
| Shrinkage (%) | | | |
| As Molded | 0.14 | 0.13 | 0.14 |
| PC 1 hour at 175° C. | 0.11 | 0.09 | 0.13 |
| Warpage, 35 mm part | | | |
| As Molded | 3.1 | 2.3 | 3.5 |
| PC 1 hour at 175° C. | 2.5 | 2 | 2.7 |

The results of Table 9 demonstrate that molding compositions prepared with a phosphonium functional acetic acid ester compound as a catalyst exhibit excellent flowability, and provide the best combination of warpage and flow characteristics when compared with molding compositions prepared with conventional catalysts.

What is claimed is:

1. A composition comprising:
a) an epoxy resin;
b) a curing agent for the epoxy resin;
c) a quaternary organophosphonium salt; and
d) a flame retardant compound.

2. The composition of claim 1, wherein the epoxy resin (a) is present in an amount of from about 1 percent to about 25 percent by weight, based on the total weight of the composition.

3. The composition of claim 1, wherein curing agent (b) is present in an amount of from about 1 percent to about 10 percent by weight, based on the total weight of the composition.

4. The composition of claim 1, wherein the compound (c) is present in at least an amount sufficient to catalytically effect crosslinking of components (a) and (b) when the composition is heated to a temperature of at least 135° C.

5. The composition of claim 1, wherein the quaternary organophosphonium salt (c) is ethyl triphenyl phosphonium acid acetate.

6. The composition of claim 1, wherein the flame retardant compound is a cyanurate functional compound.

7. The composition of claim 6, wherein the cyanurate functional compound is melamine cyanurate.

8. The composition of claim 7, wherein the melamine cyanurate is present in an amount less than about 3.0 percent by weight, based on the total weight of the composition.

9. The composition of claim 1, further comprising an inorganic filler component.

10. The composition of claim 9, wherein the inorganic filler component is selected from the group consisting of silica, alumina, aluminosilicate, aluminum trihydrate, silicon nitride, clay, talc, mica, kaolin, calcium carbonate, wollastonite, montmorillonite, smectite, and combinations thereof.

11. The composition of claim 1, wherein the composition is essentially free of bromine and antimony compounds.

12. A molding compound comprising the composition of claim 1.

13. The composition of claim 1, wherein the epoxy resin (a) is selected from the group consisting of bisphenol A type epoxy resins, novolac type epoxy resins, alicyclic epoxy resins, glycidyl type epoxy resins, biphenyl type epoxy resins, naphthalene ring-containing epoxy resins, cyclopentadiene-containing epoxy resins, polyfunctional epoxy resins, and combinations thereof.

14. The composition of claim 13, wherein the curing agent (b) is selected from the group consisting of phenol novolac type hardener, cresol novolac type hardener, dicyclopentadiene phenol type hardener, limonene type hardener, flexible type hardener, anhydrides, and combinations thereof.

15. The composition of claim 13, wherein the quaternary organophosphonium salt (c) is present in at least an amount sufficient to provide improved flame resistance to the composition after curing thereof, compared to a similar composition that does not contain a quaternary organophosphonium salt.

16. The composition of claim 1, wherein the epoxy resin (a) comprises a multifunctional epoxy resin derived from phenol and having a degree of branching of at least three and wherein the crosslinking agent (b) is derived from phenol and has a degree of branching of at least three.

17. The composition of claim 16, wherein the epoxy resin (a) comprises triphenylol methane triglycidyl ether epoxy resin, and the crosslinking agent (b) comprises a phenolic hardener derived from tris-phenol methane.

18. An encapsulant for a semiconductor device comprising a reaction product of the composition of claim 1.

19. A flame retardant molding composition, comprising:
a) at least one resin containing epoxide functional groups;
b) at least one crosslinking agent containing functional groups that are reactive with epoxide groups;
c) a cyanurate functional compound; and
d) a quaternary organophosphonium salt present in at least an amount sufficient to provide improved flame resistance to the composition after curing thereof compared to a similar composition that does not contain component (d), and wherein component (d) is present in at least an amount sufficient to catalytically effect crosslinking of components (a) and (b) when the molding composition is heated to a temperature of at least 135° C.

20. The molding composition of claim 19, wherein the quaternary organophosphonium salt is ethyl triphenyl phosphonium acid acetate.

21. The molding composition of claim 19, wherein the cyanurate functional compound is melamine cyanurate.

22. The molding composition of claim 19, further comprising an inorganic filler component.

23. A molding composition, comprising:
a) from about 20 percent to about 90 percent, based on the total weight of the composition, of an inorganic filler component;
b) from about 1 percent to about 25 percent by weight, based on the total weight of the composition, of a resin containing epoxide functional groups;
c) from about 1 percent to about 10 percent by weight, based on the total weight of the composition, of a crosslinking agent containing functional groups that are reactive with epoxide groups;
d) from about 0.1 percent to about 1 percent by weight, based on the total weight of the composition, of a quaternary organophosphonium salt; and
e) less than about 3 percent by weight, based on the total weight of the composition, of a cyanurate functional compound.

24. The molding composition of claim 23, wherein the quaternary organophosphonium salt is ethyl triphenyl phosphonium acid acetate.

25. The molding composition of claim 23, wherein the cyanurate functional compound is melamine cyanurate.

26. A molding composition, comprising:
a) from about 20 percent to about 90 percent, based on the total weight of the composition, of an inorganic filler component;
b) from about 1 percent to about 25 percent by weight, based on the total weight of the composition, of a multifunctional epoxy resin derived from phenol and having a degree of branching of at least three;
c) from about 1 percent to about 10 percent by weight, based on the total weight of the composition, of a multifunctional phenolic hardener derived from phenol and having a degree of branching of at least three; and
d) from about 0.1 percent to about 1 percent by weight, based on the total weight of the composition, of a quaternary organophosphonium salt.

27. The molding composition of claim 26, wherein the quaternary organophosphonium salt is ethyl triphenyl phosphonium acid acetate.

28. The molding composition of claim 26, further comprising a flame retardant component.

29. The molding composition of claim 28, wherein the flame retardant comprises melamine cyanurate.

30. A method of providing a flame retardant polymer composition comprising:
providing an epoxy molding composition comprising an epoxy resin, a crosslinking agent for the epoxy resin, a cyanurate functional compound and a quaternary organophosphonium salt; and
heating the epoxy molding composition to a temperature sufficient to cause the phosphonium functional acetic acid ester compound to catalytically effect crosslinking of the epoxy resin and the crosslinking agent.

31. The method of claim 30, wherein the cyanurate functional compound is melamine cyanurate.

32. The method of claim 30, wherein the quaternary organophosphonium salt is ethyl triphenyl phosphonium acid acetate.

33. The method of claim 30, wherein the quaternary organophosphonium salt is provided in the molding composition in an amount of from about 0.1 percent to about 1 percent by weight, based on the total weight of the composition.

34. The method of claim 30, wherein the temperature ranges from about 135° C. to about 195° C.

35. A method of coating an electrical or electronic device comprising heating an epoxy molding composition to a temperature sufficient to cure the molding composition and form a polymer on a surface of the device, the molding composition comprising an epoxy resin, a crosslinking agent for the epoxy resin, a cyanurate functional compound and a quaternary organophosphonium salt.

36. The method of claim 35 comprising the steps of a) providing the molding composition; b) coating a surface of the device with the molding composition; and c) heating the molding composition to a temperature sufficient to cure the molding composition and form a polymer on a surface of the device.

37. The method of claim 35, wherein the quaternary organophosphonium salt is ethyl triphenyl phosphonium acid acetate.

38. The method of claim 35, wherein the quaternary organophosphonium salt is provided in the molding composition in an amount of from about 0.1 percent to about 1 percent by weight, based on the total weight of the composition.

39. The method of claim 35, wherein the temperature ranges from about 135° C. to about 195° C.

40. The method of claim 35, wherein the device comprises a semiconductor, a transistor, a diode or an integrated circuit.

41. An electrical or electronic device formed by the method of claim 35.

42. A method of coating an electrical or electronic device with a long flow, low shrinkage encapsulant, comprising heating an epoxy molding composition to a temperature sufficient to cure the molding composition and form a polymer on a surface of the device, the molding composition comprising a multifunctional epoxy resin derived from phenol and having a degree of branching of at least three, a multifunctional phenolic hardener having a degree of branching of at least three, and a quaternary organophosphonium salt for catalyzing a reaction between the epoxy resin and the phenolic hardener.

43. The method of claim 42 comprising the steps of a) providing the molding composition; b) coating a surface of the device with the molding composition; and c) heating the molding composition to a temperature sufficient to cure the molding composition and form a polymer on a surface of the device.

44. The method of claim 42, wherein the quaternary organophosphonium salt is ethyl triphenyl phosphonium acid acetate.

45. The method of claim 42, wherein the quaternary organophosphonium salt is present in the molding composition in an amount of about 0.1 to 1 percent by weight, based on the total weight of the molding composition.

46. The method of claim 42, wherein the temperature ranges from about 135° C. to about 195° C.

47. The method of claim 42, wherein the device comprises a semiconductor, a transistor, a diode, or an integrated circuit.

48. A device formed by the method of claim 42.
